(19) United States
(12) Patent Application Publication
(10) Pub. No.: US 2004/0182527 A1
(43) Pub. Date: Sep. 23, 2004

(54) Cord stopper for window blind assembly and window blind assembly using same

(75) Inventor: Ming Nien, Changhua Hsien (TW)

Correspondence Address: BACON & THOMAS, PLLC, 625 SLATERS LANE, FOURTH FLOOR, ALEXANDRIA, VA, 22314

(73) Assignee: NIEN MADE ENTERPRISE CO., LTD., TAICHUNG (TW)

(21) Appl. No.: 10/795,422

(22) Filed: Mar. 9, 2004

(30) Foreign Application Priority Data
Mar. 17, 2003 (TW) 92204432

(51) Int. Cl. E06B 9/324

(52) U.S. Cl. 160/178.2

(57) ABSTRACT

A cord stopper for use in slidably and detachably connecting a lift cord of a window blind assembly includes a first portion provided with a cord hole, a second portion having a free end close to the first portion, and a cord-holding portion connected between the first portion and the second portion. The lift cord is folded up and inserted through the cord hole of the cord stopper to form a loop which is hung on the cord-holding portion of the cord stopper.

### BACKGROUND OF THE INVENTION

1. Field of the Invention

The present invention relates generally to a window blind assembly and more particularly, to a window blind assembly having cord stoppers.

2. Description of the Related Art

Window blind assemblies are intensively used to decorate windows and to shield outside incident light from windows. A window blind assembly constructed according to U.S. Pat. No. 6,453,974 is shown in FIG. 1, comprising a headrail 11, a bottom rail 12, a blind supporting system 13 joining the headrail 11 and the bottom rail 12 and mounted with a plurality of slats 14, two lift cords 15 each having a first portion 152 affixed to one end of the bottom rail 12 and upwardly penetrated through the slats 14 and the headrail 11 and a second portion 151 extended out of the headrail 11 via a cord lock 16 near one end of the headrail 11. The second portion 151 of each lift cord 15 is for pulling by the user to control the elevation of the bottom rail 12, i.e., changing the length of the second portion 151 of each lift cord 15 relatively control the extending (unfolding) status of the window blind assembly. A window blind assembly of this design is not safe in use. Because the first portion 152 of each lift cord 15 that passes through the slats 13 can easily be pulled by a child, and an accident may occur when a child playing with the first portion 152 of each lift cord 15 for fun and hang the first portion 152 of each lift cord 15 on the neck accidentally. Further, the cord lock 16 may fail, thereby causing the slats 14 and the bottom rail 12 to fall suddenly and to further hit a person below accidentally. In order to eliminate these problems, U.S. Pat. No. 6,453,974 uses two cord stoppers 17 connected respectively to the second portion 151 of each lift cord 15 to limit stretching of the first portion 152 of each lift cord 15. According to this design, each cord stopper comprises a locking guider having at least a guiding through slot provided thereon; each locking guider is slidably connected to the respective lift cord by tying an adjustable knot at the guiding through slot; each adjustable knot is constructed to be capable of passing through the respective guiding through slot in order to move the adjustable knot between an upper position and a lower position with respect to the locking guider; the adjustable knot is constructed by tying the lift cord on the locking guider by forming a loop on the lift cord, passing the loop through the respective guiding through slot and penetrating the free end portion of the lift cord into the loop so as to form the adjustable knot tying around the locking guider. This installation procedure is complicated and inconvenient.

Therefore, it is desirable to provide a window blind assembly having one or more cord stoppers that eliminate the aforesaid problem.

### SUMMARY OF THE INVENTION

It is the primary objective of the present invention to provide a window blind assembly having at least one lift cord stopper, which prevents excessively stretching of the lift cords that pass through the slats.

It is another objective of the present invention to provide a window blind assembly having at lease one lift cord stopper, which presents falling of the bottom rail from the top position accidentally due to failure of the cord lock.

It is still another objective of the present invention to provide a window blind assembly having at lease one lift cord stopper, which lift cord stopper is easy to install.

To achieve these objectives of the present invention, the window blind assembly comprises a headrail, a bottom rail, a plurality of slats, a supporting unit connected to the headrail, the bottom rail and the slats for supporting the slats between the headrail and the bottom rail, a cord lock mounted on the headrail, a pair of lift cords each having an end affixed to the bottom rail and a portion extended out of the headrail through the cord lock, and at least one cord stopper. The cord stopper has a first portion provided with a cord hole, a second portion having a free end close to the first portion, and a cord-holding portion connected between the first and second portions. The portion of the lift cord is folded up and inserted through the cord hole of the cord stopper to form a loop which is hung on the cord-holding portion of the cord stopper.

### BRIEF DESCRIPTION OF THE DRAWINGS

FIG. 1 is a perspective view of a window blind assembly constructed according to U.S. Pat. No. 6,453,974.

FIG. 2 is a perspective view of a window blind assembly constructed according to the present invention.

FIG. 3 is a perspective view of a cord stopper according to the present invention.

FIG. 4 is a schematic drawing showing a first step of the installation procedure of the cord stopper in the lift cord according to the present invention.

FIG. 5 is a schematic drawing showing a second step of the installation procedure of the cord stopper in the lift cord according to the present invention.

FIG. 6 is a schematic drawing showing another installation example of the cord stopper in the lift cord according to the present invention.

FIG. 7 is similar to FIG. 2 but showing one cord stopper stopped at the headrail.

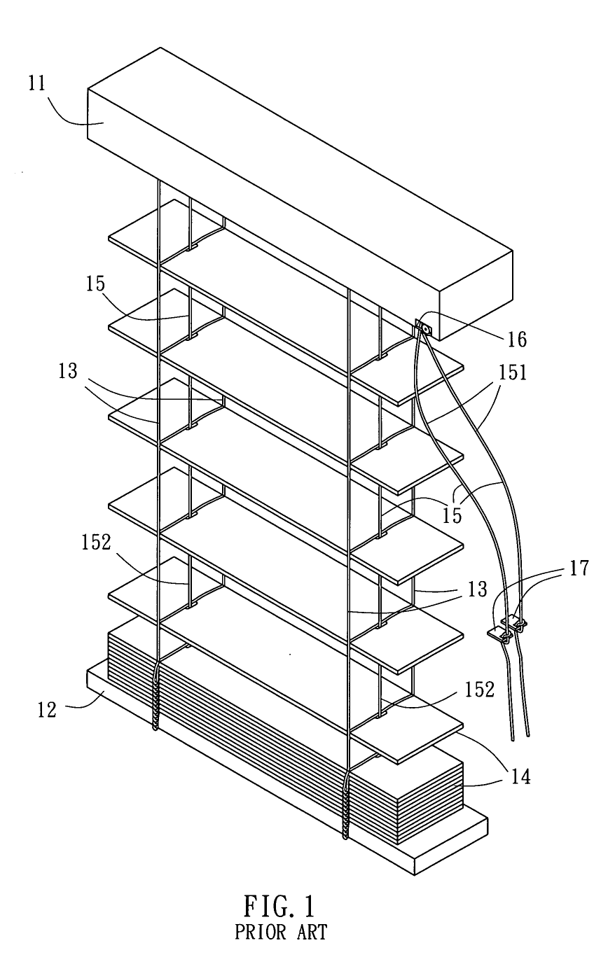

### DETAILED DESCRIPTION OF THE INVENTION

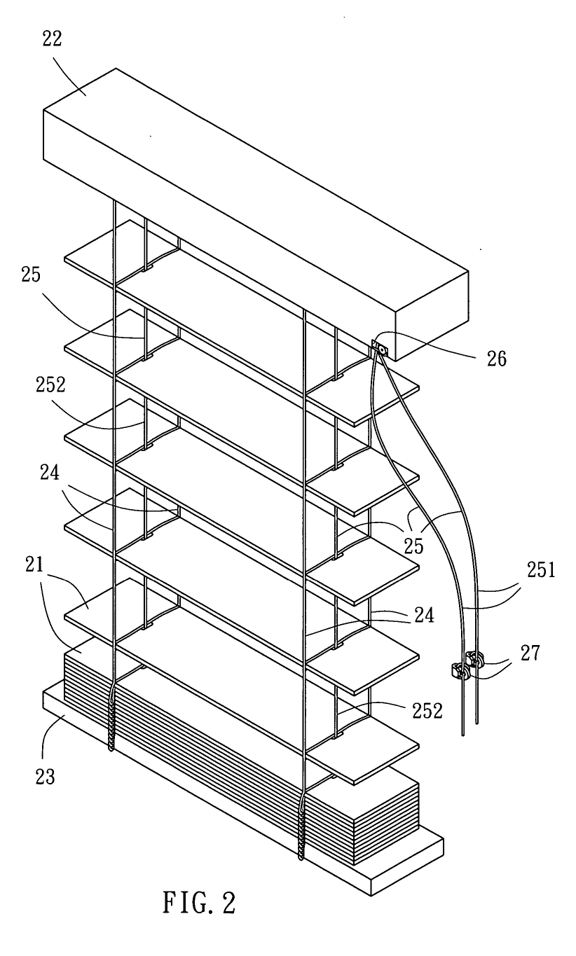

As shown in FIG. 2, a window blind assembly is shown comprising a headrail 22, a bottom rail 23, a plurality of slats 21, a supporting unit including two ladder tapes 24 connected to the headrail, the bottom rail and the slats for spacedly supporting the slats 21 horizontally between the headrail 22 and the bottom rail 23, a pair of lift cords 25 each having an end (not shown) affixed to the bottom rail 23, a first portion 252 upwardly penetrated through the slats 21 and then transversely extended through the headrail 22, and a second portion 251 extended out of the headrail 22 via a cord lock 26 to control the folding and unfolding of the window blind assembly, and two cord stoppers 27 respectively fastened to the second portions 251 of the lift cords 25.

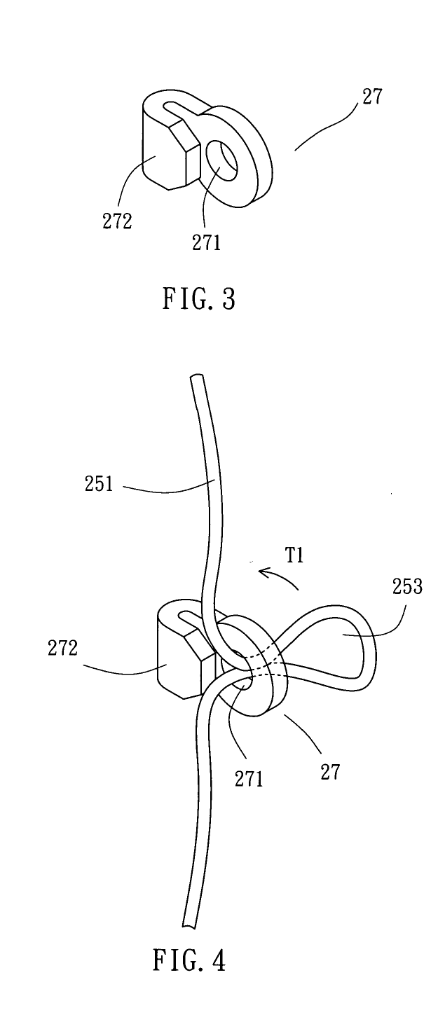

As sown in FIG. 3, the cord stopper 27 is a curved plate member having a first portion provided with a cord hole 271, a second portion terminating in a free end close to the first portion, a curved cord-holding portion 272 integrally connected between the first portion and the second portion for holding the lift cord 25 thereon.

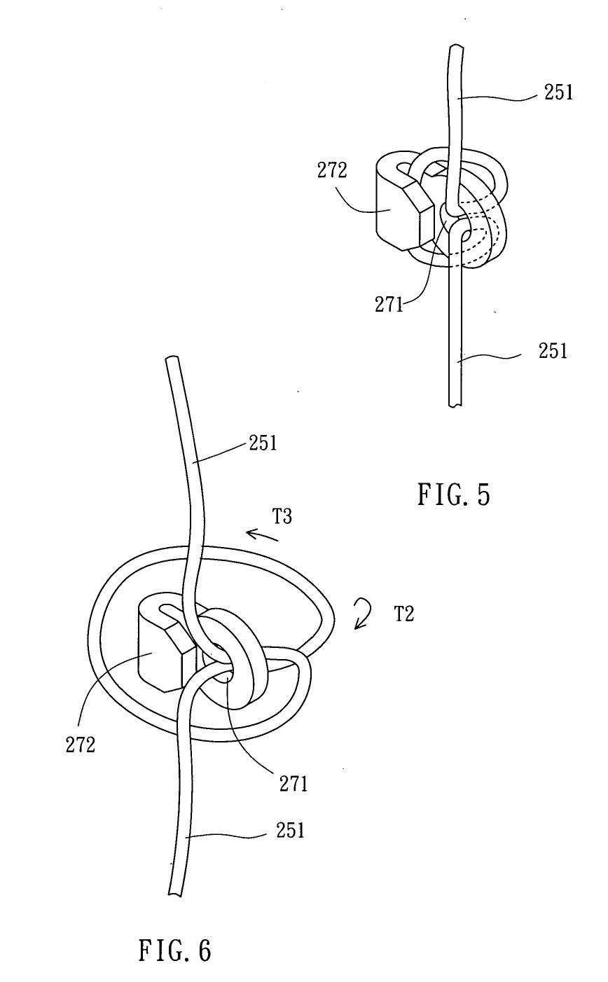

As shown in FIGS. 4-5, the second portion 251 of the lift cord is folded up and then inserted through the cord hole 271 of the cord stopper 27, forming a loop 253, and then the loop 253 is pulled backwards (see the direction indicated by arrowhead sign T1 in FIG. 4), and hung on the cord-holding portion 272 as shown in FIG. 5. Alternatively, as shown in FIG. 6 the loop 253 thus formed can be twisted through 180° (see the direction indicated by arrowhead sign T2 in FIG. 6) at first. And then, the twisted loop 253 is pulled backwards (see the direction indicated by arrowhead sign T3 in FIG. 6) and hung on the cord-holding portion 272. The fastening method of FIG. 6 increases the friction of cord, enhancing positioning of the cord stopper 27 at the second portion 251. In either of the aforesaid two methods, the cord stoppers 27 must be spaced from the cord lock 26 at a certain distance.

Normally, the sliding status of the lift cords 25 of the invention is controlled by means of the cord lock 26. If the cord lock 26 failed, the slats 21 and the bottom rail 23 fell due to gravity weight. Falling of the bottom rail 23 drives the lift cords 25, thereby causing the second portions 251 of the lift cords 25 to slide toward the cord lock 26, and the cord stoppers 27 are respectively moved with the second portions 251 of the lift cords 25 and then stopped at the cord lock 26 where the cord stoppers 27 lock up the downward falling movement of the bottom rail 23.

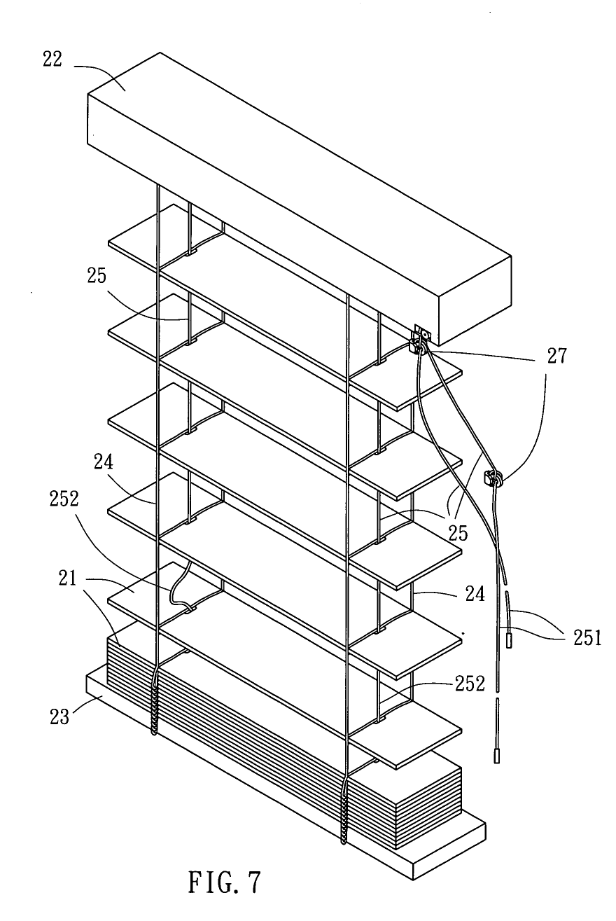

As shown in FIG. 7, if a child pulled the first portion 252 of one lift cord 25 between two adjacent slats 21 for fun, the respective cord stopper 27 will be moved upwards and stopped at the cord lock 26 in case the cord lock 26 failed at this time, preventing excessive stretching of the first portion 252.

As indicated above, the invention has numerous advantages as outlined hereinafter.

1. By means of the cord stoppers 27, the invention limits sliding of the lift cords 25 even if the cord lock 26 fails.

2. By means of inserting the middle part of the second portion 251, the cord stopper 27 is easily fastened to the respective lift cord 25.

3. By means of the cord stoppers 27, the moving distance of the bottom rail or the stretching distance of the lift cords is well controlled, preventing an accident.

4. The free end of the second portion of the stopper is designed close to the first portion of the cord stopper 27, thereby preventing the loop formed of the second portion of the respective lift cord from escape from the cord-holding portion through the gap between the free end of the second portion of the stopper and the first portion of the stopper.

5. When loosening the loop 253 of the second portion 251 from the respective cord stopper 27, the respective cord stopper 27 can then be moved adjusted to another position on the respective lift cord 25 easily.

6. The cord stoppers can be used in a conventional window blind assembly without making any structural change of the window blind assembly.

7. The cord stoppers have a nice outer looking.

It is to be understood that although particular embodiment of the invention has been described in detail for purposes of illustration, various modifications and enhancements may be made without departing from the spirit and scope of the invention. For example, the cord hole 271 may be made relatively bigger. Alternatively, two or more cord-holding portions and/or cord holes 271 may be formed on one cord stopper so that a number of lift cords 25 can be fastened to one common cord stopper, preventing interference of one cord stopper with the other. Accordingly, the invention is not to be limited except as by the appended claims.

What is claimed is:

1. A window blind assembly comprising:
a headrail;
a bottom rail;
a plurality of slats;
a supporting unit connected to said headrail, said bottom rail and said slats for supporting said slats between said headrail and said bottom rail;
a cord lock mounted on said headrail;
a pair of lift cords each having an end affixed to said bottom rail, a first portion penetrated through said slats and extended through said headrail, and a second portion extended out of said headrail through said cord lock for operation to control elevation of said bottom rail; and
at least one cord stopper having a first portion provided with a cord hole, a second portion having a free end close to the first portion of said cord stopper, and a cord-holding portion connected between the first and second portions of said cord stopper;
wherein the second portion of each said lift cord is folded up and inserted through the cord hole of said cord stopper to form a loop that is hung on the cord-holding portion of said cord stopper.

2. The window blind assembly as claimed in claim 1, wherein said loop is twisted through 180° before hanging on the cord-holding portion of said cord stopper.

3. The window blind assembly as claimed in claim 2, wherein said supporting unit comprises at least two ladder tapes.

4. A cord stopper for slidably and detachably connecting a lift cord of a window blind assembly, said cord stopper having a first portion provided with a cord hole, a second portion having a free end close to the first portion, and a cord-holding portion connected between the first portion and the second portion.

5. The cord stopper as defined in claim 4, wherein said cord stopper is a curved plate member.

6. The cord stopper as defined in claim 4, wherein said cord-holding portion is integrally connected between the first portion and the second portion.
